(19) United States
(12) Patent Application Publication
(10) Pub. No.: US 2025/0167862 A1
(43) Pub. Date: May 22, 2025

(54) BEAM SELECTION BASED ON USER EQUIPMENT DEVICE HEADING

(71) Applicants: Henry CHANG, San Diego, CA (US); Amit KALHAN, San Diego, CA (US); Kyocera Corporation, Kyoto (JP)

(72) Inventors: Henry CHANG, San Diego, CA (US); Amit KALHAN, San Diego, CA (US)

(21) Appl. No.: 18/838,560

(22) PCT Filed: Mar. 10, 2023
(86) PCT No.: PCT/US2023/014951

§ 371 Date: Aug. 14, 2024

Related U.S. Application Data
(60) Provisional application No. 63/318,697, filed on Mar. 10, 2022.
(60) Provisional application No. 63/328,847, filed on Apr. 8, 2022.

(51) Int. Cl. H04B 7/06; H04B 7/0456

(52) U.S. Cl. CPC H04B 7/0695; H04B 7/0456

(57) ABSTRACT

In some of the examples described herein, a base station determines, based on a location of a user equipment (UE) device, an initial set of one or more consecutive beams over which to transmit a Synchronization Signal Block (SSB) signal. The base station serially transmits the SSB signal to the UE device via the initial set of one or more consecutive beams. In response to failure of the UE device to successfully receive the SSB signal transmission via the initial set of one or more consecutive beams, the base station determines, based on heading information of the UE device, a second set of one or more consecutive beams over which to transmit the SSB signal. The base station serially transmits the SSB signal to the UE device via the second set of one or more consecutive beams in a direction associated with the heading information of the UE device.

### CLAIM OF PRIORITY

The present application claims priority to Provisional Application No. 63/318,697, entitled “POSITIONING ASSISTED INITIAL BEAMFORMING,” docket number TPRO 00371 US, filed Mar. 10, 2022 and to Provisional Application No. 63/328,847, entitled “BEAM SELECTION BASED ON UE'S HEADING,” docket number TPRO 00372 US, filed Apr. 8, 2022, both assigned to the assignee hereof and hereby expressly incorporated by reference in their entirety.

### FIELD

This invention generally relates to wireless communications and more particularly to selecting a set of beams for communicating with a user equipment (UE) device.

### BACKGROUND

Beamforming is a traffic-signaling system for cellular base stations that identifies the most efficient spatial-directional delivery of data to a particular user equipment (UE) device while reducing interference for other, nearby UE devices. Beamforming involves focusing a signal in a concentrated beam that points in the direction of a particular UE device rather than broadcasting the signal in all directions at once.

### SUMMARY

In some of the examples described herein, a base station determines, based on a location of a user equipment (UE) device, an initial set of one or more consecutive beams over which to transmit a Synchronization Signal Block (SSB) signal. The base station serially transmits the SSB signal to the UE device via the initial set of one or more consecutive beams. In response to failure of the UE device to successfully receive the SSB signal transmission via the initial set of one or more consecutive beams, the base station determines, based on heading information of the UE device, a second set of one or more consecutive beams over which to transmit the SSB signal. The base station serially transmits the SSB signal to the UE device via the second set of one or more consecutive beams in a direction associated with the heading information of the UE device.

### BRIEF DESCRIPTION OF THE DRAWINGS

FIG. 1 is a block diagram of an example of a system in which a base station communicates with a user equipment (UE) device located at a particular angle and distance from the base station.

FIG. 2A is a block diagram of an example of the base station shown in FIGS. 1 and 3.

FIG. 2B is a block diagram of an example of the user equipment devices shown in FIGS. 1 and 3.

FIG. 3 is a block diagram of an example of the system of FIG. 1 in which the base station determines the distance to one UE device based on location information received from another UE device.

FIG. 4 is a flow chart of an example of a method performed at a base station to determine an initial beam, based on a location of a UE device, over which to transmit an SSB signal.

### DETAILED DESCRIPTION

A multiple-input, multiple-output (MIMO) base station uses multiple antennas to transmit signals to one or more intended user equipment (UE) devices. MIMO may also refer to a class of techniques for sending and receiving more than one data signal simultaneously over the same radio channel by exploiting multipath propagation.

A MIMO base station uses narrow beams to transmit data to a particular UE device within the coverage area of the base station since higher frequency bands have high pathloss. Obviously, a narrow beam can only reach a small portion of the coverage area at a given time. Thus, the base station performs a beam sweeping operation to reach the different parts of the coverage area.

Similarly, the UE device within the coverage area of the base station also performs its own sweeping operation to determine the best link to communicate with the base station. The UE device obtains the best link when the transmitting and the receiving beam pair is optimal for the UE device at a particular time. Depending upon the number of beams and the coverage area size, the beam sweeping operation can be time consuming. In practice, the beam sweeping operation takes several iterations, starting with an initial sub-optimal beam pair. After exchanging further channel state information (CSI) between the base station and the UE device, a beam refinement process is performed until the optimal transmitting and receiving beam pair are determined.

In the 3rd Generation Partnership Project 5G New Radio (3GPP 5G NR) communication specification, the base station transmits a Synchronization Signal Block (SSB) signal during the beam sweeping procedure using one beam in one direction and then transmits the next SSB block to a different direction using a different beam and so on. The SSB signal is repeatedly transmitted to a different direction using a different beam until the SSB signal is effectively transmitted to all portions of the coverage area. This burst of SSB transmissions are repeated with a fixed periodicity (e.g., time interval) known to the UE devices located in the coverage area of the base station.

A UE device that receives the SSB transmissions performs beam strength measurements on each of the received SSB transmissions. Based on a comparison of the beam strength measurements, the UE device transmits a report to the base station indicating the best beam (e.g., SSB index). The report from the UE device enables the base station to determine an initial beam direction to apply for transmissions to the reporting UE device.

The total time required for a UE device to determine an optimal beam pair is a function of the number of beams received by the UE device and the periodicity of the SSB transmissions. This could be a large delay if the number of beams is large. If a fewer number of beams are used to save time, then there is a chance that the beam selected by the UE device could cause interference to other neighboring UE devices since the beamwidth in such a scenario would be wider (e.g., covering a larger area). In this situation, the base station is required to receive CSI reports from the neighboring UE devices to further refine beamforming to mitigate interference. This refinement adds further delay and signaling overhead. The devices, systems, and methods described below may advantageously reduce the delays and inefficiencies associated with these types of beam sweeping procedures that are currently utilized to determine the optimal beam pair.

For example, the devices, systems, and methods described herein utilize a location and/or heading information of the UE device to determine an initial beam or set of beams on which to begin transmitting to that UE device. In this regard, there are several methods to obtain the geo-location of the UE devices within a coverage area of a base station. One method involves Global Navigation Satellite System (GNSS) capable UE devices sending their location to the base station. Device-to-Device (D2D) Positioning, which is the preferred method in terms of its lower signaling overhead and latency, is another method to obtain the location of the UE devices.

Another method involves the base station requesting the UE devices to transmit a Sounding Reference Signal (SRS) or send their measurements of Positioning Reference Signals (PRS) received from other neighboring base stations. In the SRS-based procedure, the base station computes the geo-location of the UE device by measuring the strength of the received SRS signal and the Angle-of-Arrival (AoA) of the SRS signal. In the PRS-based procedure, the base station computes the location of the UE device using the triangulation method.

The foregoing UE device location determination methods help to build a positioning database that lists the UE device identifiers (UE IDs) and their associated geo-locations. The base station continuously tracks the location of each of the UE devices by requesting the UE devices to periodically transmit the relevant location information (e.g., D2D Neighbor Lists, SRS, or PRS measurements, etc.).

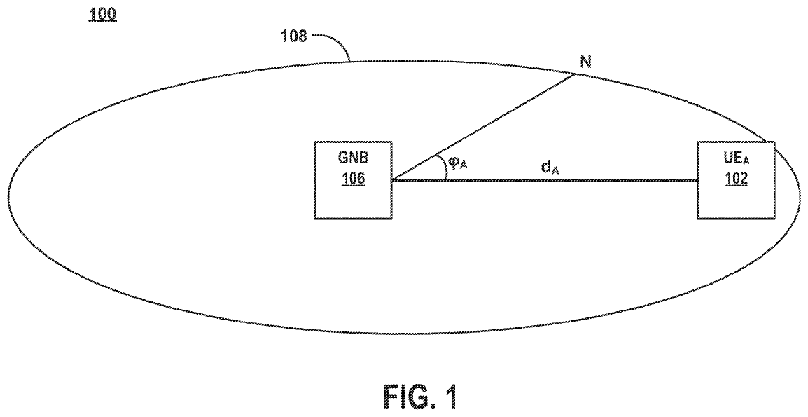

The direct communication channel between a base station with multiple transmit elements and a single-antenna UE device is known as a multiple-input, single-output (MISO) Line-Of-Sight (LOS) channel. In a MISO LOS channel, the UE device has a LOS channel in a particular direction and distance (e.g., channel vector, h) from a multi-antenna base station. An example of a MISO LOS channel is shown and described more fully below in connection with FIG. 1.

The examples described herein are mainly directed to base stations that utilize Uniform Linear Antenna (ULA) arrays, where the antenna elements are evenly spaced on a straight line. However, the concepts described herein may be applied to other array structures and MIMO configurations.

In some examples, the MISO channel between the base station and a UE device is based on the number of antenna elements N at the base station and the distance, d, between the base station and the UE device. Since the antenna array dimension is much smaller than the distance between the base station and the UE device, the path attenuation is the same for all antenna elements determined by the carrier-frequency channel models.

In some of the examples described herein, a base station determines, based on a location of a user equipment (UE) device, an initial set of one or more consecutive beams over which to transmit a Synchronization Signal Block (SSB) signal. The base station serially transmits the SSB signal to the UE device via the initial set of one or more consecutive beams. In response to failure of the UE device to successfully receive the SSB signal transmission via the initial set of one or more consecutive beams, the base station determines, based on heading information of the UE device, a second set of one or more consecutive beams over which to transmit the SSB signal. The base station serially transmits the SSB signal to the UE device via the second set of one or more consecutive beams in a direction associated with the heading information of the UE device.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

FIG. 1 is a block diagram of an example of a system in which a base station communicates with a user equipment (UE) device located at a particular angle and distance from the base station. In the interest of brevity, FIG. 1 only depicts one UE device 102. However, any number of UE devices may be utilized, in other examples.

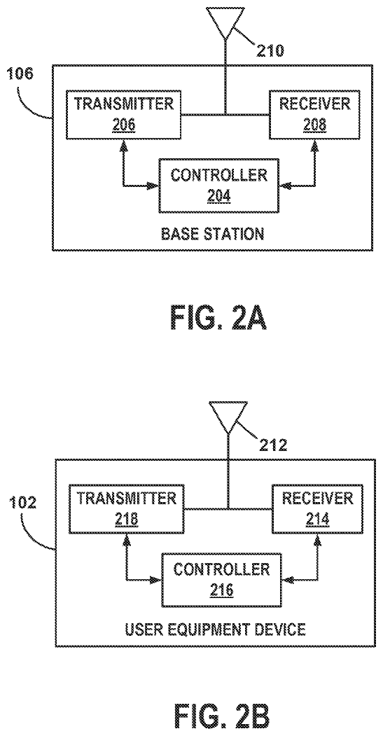

As shown in FIG. 2B, user equipment device (UE) 102 comprises controller 216, transmitter 218, receiver 214, and antenna 212, as well as other electronics, hardware, and software code. UE device 102 may also be referred to herein as a UE or as a wireless communication device (WCD). UE 102 is wirelessly connected to a radio access network (not shown) via base station 106, which provides various wireless services to UE 102. For the example shown in FIG. 1, UE 102 operates in accordance with at least one revision of the 3rd Generation Partnership Project 5G New Radio (3GPP 5G NR) communication specification. In other examples, UE 102 may operate in accordance with other communication specifications. For the example shown in FIG. 1, UE 102 has the same components, circuitry, and configuration as UE 102 from FIG. 2B. However, UE 102 in FIG. 1 may have components, circuitry, and configuration that differ from UE 102 in FIG. 2B, in other examples.

UE 102 is any fixed, mobile, or portable equipment that performs the functions described herein. The various functions and operations of the blocks described with reference to UE 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the interest of clarity and brevity, only one base station is shown in FIG. 1. However, in other examples, any suitable number of base stations may be utilized. In the example of FIG. 1, base station 106 provides wireless services to UEs within coverage area 108. Although not explicitly shown, coverage area 108 may be comprised of multiple cells. For the example shown in FIG. 1, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

As shown in the example of FIG. 1, system 100 includes base station 106 having coverage area 108. UE device 102 (e.g., UE_{A}) is located in coverage area 108. More specifically, UE device 102 is located along an angle, DA, and at a distance, da, from base station 106. In the example shown in FIG. 1, the angle DA is the horizontal angle (e.g., azimuth) from a cardinal direction (e.g., north). In other examples, the angle (A may be determined relative to any other suitable reference direction.

In operation, base station 106 utilizes its controller 204 to determine, based on a location of UE device 102, an initial estimate of at least one characteristic of a MISO channel. In this regard, the initial estimate of the at least one characteristic of the MISO channel is a first step in determining the initial beam over which the SSB signal will be transmitted rather than performing a beam sweeping operation over the entire base station coverage area, as described above. The techniques described herein to determine the initial beam can be performed any time a base station and a UE device are attempting to initiate or adjust communication with each other via beamforming, in some examples. The MISO channel is characterized by a vector (e.g., direction and distance) between base station 106 and UE device 102. In some examples, base station 106 may obtain the location of UE device 102 by any suitable method, including the methods mentioned above.

In some examples, the at least one characteristic of the MISO channel is a complex gain coefficient, which can be measured at each antenna element per subcarrier. Complex gain can be expressed as magnitude-angle or Real-Imaginary values, in some examples. Therefore, the vector characterizing the MISO channel can be established or adjusted by setting the complex gain coefficient. Other characteristics can be manipulated in addition to the complex gain coefficient to adjust the vector.

Base station 106 further utilizes its controller 204 to apply a precoder to a Synchronization Signal Block (SSB) signal to determine an initial beam on which to transmit the SSB signal. Precoding is a technique that exploits transmit diversity (e.g., from each antenna element of the base station) by appropriately weighting the information stream (e.g., SSB signal) such that the signal power is maximized when transmitting the signal to the receiver (e.g., UE device). The precoder is based on the initial estimate of the at least one characteristic of the MISO channel.

In some examples, the precoder is one of a plurality of predefined precoders, and the precoder directs the initial beam with an angle of incidence towards the location of UE device 102. In some examples, a complex-conjugate of the MISO channel is considered the optimal precoder. In other examples, minimum-mean-squared error (MMSE) or Zero-Forcing precoders are used.

Once the initial beam has been determined, base station 106 transmits, via its transmitter 206 and antenna 210, the SSB signal to UE device 102 via the initial beam. In some examples, the SSB signal is transmitted with a transmit power that is based on the distance between UE device 102 and base station 106.

UE device 102 receives, via its antenna 212 and receiver 214, the SSB signal over the initial beam. In response to receiving the SSB signal, UE device 102 transmits, via its transmitter 218 and antenna 212, a received signal strength of the SSB signal to base station 106. In some examples, UE device 102 transmits the received signal strength of the SSB signal before the expiration of a timer. In further examples, the timer is a network-configured timer.

Base station 106 receives, via its antenna 210 and receiver 208, the received signal strength of the SSB signal from UE device 102. In response to the received signal strength of the SSB, base station 106 utilizes its transmitter 206 to adjust the SSB signal, based on the received signal strength, for retransmission to UE device 102, in some examples. In further examples, base station 106 utilizes its transmitter 206 to adjust the transmit power of the SSB signal for retransmission to UE device 102.

The foregoing description of the operation of system 100 of FIG. 1 is generally applicable to examples in which the MISO channel between the gNB and the UE device has low angular spread such that the initial SSB beam transmission is likely to be successful. However, there may be scenarios when the UE location-assisted initial beamforming scheme may not be optimal. One such situation is when the UE may not report back the received signal strength before the timer expires (e.g., if the UE has moved to a different location). Another reason for the UE not to report back is the MISO channel between the gNB and the UE has a high angular spread (e.g., a Non-Line-Of-Sight (NLOS) scenario), and the UE was not able to successfully receive the SSB transmission over the initial beam.

One approach to handling the UE's mobility and/or NLOS situations is to transmit the initial transmission in the direction of the UE's location with a group of consecutive Grid of Beams (GoB) beams. The selected group of consecutive GoB beams are transmitted one at a time. If the UE fails to successfully receive the transmission via the initial group of beams, the gNB selects another group of narrow beams for the retransmission, which is a few degrees away in one direction, and then selects another group of narrow beams on the other side of the initial transmission's direction, and so on. It must be noted this approach assumes, given a short reporting periodicity, there is a good chance the UE's location has not changed much from the time instance the location was last reported. In general, this scheme is better than starting an exhaustive beam search with a random beam direction.

Thus, to execute the foregoing approach, base station 106 utilizes its transmitter 206 and antenna 210 to serially transmit the SSB signal to UE device 102 via a first group of one or more additional consecutive beams (e.g., in addition to the initial beam), in some examples. In further examples, base station 106 utilizes its transmitter 206 and antenna 210 to serially transmit the SSB signal to UE device 102 via a second group of one or more additional consecutive beams. In these examples, the second group is a pre-defined number of degrees (e.g. 5 degrees) away from the first group in a first direction (e.g., clockwise from (A). In still further examples, base station 106 utilizes its transmitter 206 and antenna 210 to serially transmit the SSB signal to UE device 102 via a third group of one or more additional consecutive beams. In these examples, the third group is the pre-defined number of degrees (e.g., 5 degrees) away from the first group in a second direction (e.g., counter-clockwise from φ_{A}).

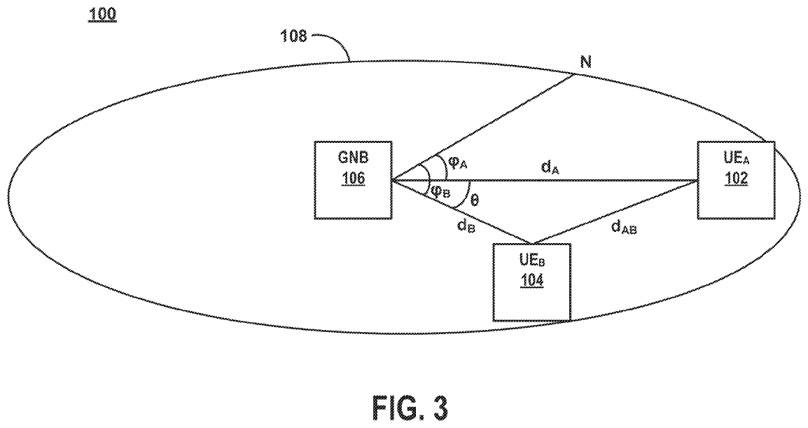

In examples in which there are at least two UEs in coverage area 108, Device-to-Device (D2D) Positioning may be used to provide UE location information to base station 106. One potential advantage of D2D Positioning over the GNSS/SRS/PRS positioning methods is that D2D Positioning has lower signaling overhead and latency. FIG. 3 provides an example of using D2D Positioning within system 100.

More specifically, FIG. 3 is a block diagram of an example of the system of FIG. 1 in which the base station determines the distance to one UE device based on location information received from another UE device, which happens to be already in the CONNECTED state (e.g., in communication with the base station). As can be seen in FIG. 3, UE device 102 is referred to as UE_{A}, and UE device 104 is referred to as UE_{B}. For the example of FIG. 3, UE device 104 has the same components, circuitry, and configuration as UE 102 from FIG. 2B. However, UE 104 may have components, circuitry, and configuration that differ from UE 102 in FIG. 2B, in other examples.

Considering the two-UE scenario shown in FIG. 3, UE_{A} 102 reports to base station 106 the distance dA_{B}, which is the distance between UE_{A} 102 and UE_{B} 104. Base station 106 applies this inter-UE distance dA_{B} to derive the distance d between base station 106 and UE_{B} 104. Given da and dB, base station 106 computes the Angle-of-Separation (AoS) between the UE_{A} 102 and UE_{B} 104. The derived AoS, θ, is used to calculate the angle of incidence for UE_{B} 104, which is φ_{B}=φ_{A}+0. Base station 106 then estimates the channel between base station 106 and UE_{B} 104. Base station 106 applies a beam precoder, based on the estimated channel between base station 106 and UE_{B} 104, to the SSB signal to determine an initial beam on which to transmit the SSB signal to reach UE_{B} 104.

Thus, if the inter-UE distance dA_{B} is available, base station 106 does not require CSI feedback from UE_{B} 104, at least for the initial transmission, to compute the precoder. As a result, the signaling overhead and the processing delay are reduced. As noted earlier, in 3GPP 5G NR, the gNB selects a GoB beam or SSB Index with the AoS e away from the GoB beam or SSB Index directed towards UE_{A} 102. In this example, the beam towards UE_{B} 104 has a gain proportional to distance dB.

Thus, in examples performed according to the D2D Positioning approach, the at least one characteristic of the MISO channel is based on a distance between the UE device and another UE device (e.g., inter-UE distance dA_{B}). In further examples, the distance (e.g., dB) is based on location information received from another UE device (e.g., UE_{A} 102). In still further examples, the at least one characteristic of the MISO channel is based on an angle of incidence (e.g., (B) towards the location of the UE device (e.g., UE_{B} 104). In other examples, the initial beam is an angle-of-separation (e.g., 0) away from another beam directed towards another UE device (e.g., UE_{A} 102). In some of these examples, the initial beam has a gain that is proportional to a distance (e.g., dB) of the UE device (e.g., UE_{B} 104) from base station 106.

In other examples for handling the UE's mobility and/or NLOS situations, an initial set of one or more consecutive Grid of Beams (GoB) beams is selected over which to transmit the initial transmission in the direction of the location of the UE. The selected set of consecutive GoB beams are transmitted one at a time (e.g., serially). If the UE fails to successfully receive the transmission via the initial set of beams, the gNB selects another set of beams for retransmission, based on heading information of the UE device. In other examples, instead of selecting a different set of narrow-beam GoB beams, the gNB could apply a precoder from a different set of wider-width GoB precoders.

To execute the foregoing approach in which a different set of beams are selected, base station 106 utilizes its controller 204 to determine, based on a location of UE device 102, an initial set of one or more consecutive beams over which to transmit the SSB signal. Base station 106 serially transmits, via transmitter 206 and antenna 210, the SSB signal to UE device 102 via the initial set of one or more consecutive beams. In response to failure of UE device 102 to successfully receive the SSB signal transmission via the initial set of one or more consecutive beams, base station 106, utilizes controller 204 to determine, based on heading information of UE device 102, a second set of one or more consecutive beams over which to transmit the SSB signal. Base station 106 serially transmits, via transmitter 206 and antenna 210, the SSB signal to UE device 102 via the second set of one or more consecutive beams in a direction associated with the heading information of UE device 102.

In some examples, a UE device periodically transmits relevant information (e.g., SRS or PRS measurements or D2D Neighbor Lists) from which the gNB can track the heading of the UE device. In some examples, the gNB submits a request for relevant information (e.g., SRS, PRS measurements and/or Neighbor Lists) via a System Information Block (SIB) message to a UE device. In other examples, the UE device may be pre-configured by the network to provide the relevant information.

In the examples in which the base station requests the relevant information, base station 106 utilizes its transmitter 206 and antenna 210 to transmit, to UE device 102, one or more instructions instructing UE device 102 when to begin and end the periodic transmissions of relevant information. In some examples, base station 106 transmits the one or more instructions in a SIB message. In other examples, base station 106 transmits the one or more instructions in a paging message to inform a specific UE device of the periodic transmissions and provides a duration for the periodic transmissions (e.g., when to stop the periodic transmissions). In further examples, base station 106 transmits the one or more instructions via dedicated signaling to a specific UE device. In still further examples, the one or more instructions may include a Destination Layer 2 identifier (ID), which may be applicable for a particular UE device, a group of UE devices, or a particular application. In one example, the one or more instructions could inform an RRC Connected UE device to obtain location information of a neighbor UE device according to the Destination layer 2 identifier or L2ID. In another example, the one or more instructions could inform an RRC Connected UE device to relay the instruction to a neighbor UE device according to the Destination layer 2 identifier or L2ID.

Base station 106 utilizes its antenna 210 and receiver 208 to receive, from UE device 102, the periodic transmissions of the relevant information. Base station 106 utilizes controller 204 to determine, based on the periodic transmissions, the heading information of UE device 102.

Returning to the example of FIG. 3, in which there are at least two UEs in coverage area 108, Device-to-Device (D2D) Positioning may be used to provide UE location information to base station 106 to facilitate selection of a set of beams over which to serially transmit an SSB signal. In some examples, UE_{B} 104 receives, via its antenna 212 and receiver 214, from UE_{A} 102, a request to establish a PC5 communication link with UE_{B} 104. Once the PC5 communication link is established, UE_{A} 102 may request that UE_{B} 104 begin sending the relevant information over the PC5 communication link. In some examples, UE_{A} 102 transmits the request in a PC5-Radio Resource Control (PC5-RRC) message or a PC5-S message. UE_{B} 104 transmits, to UE_{A} 102 via the PC5 communication link, one or more signals from which UE_{A} 102 determines heading information for UE_{B} 104 and reports the heading information to base station 106. In some examples, the one or more signals from which UE_{A} 102 determines heading information for UE_{B} 104 are reference signals.

In other examples, UE_{B} 104 also receives, via a discovery message from UE_{A} 102, a request for UE_{B} 104 to transmit positioning information associated with UE_{B} 104. In response, UE_{B} 104 transmits one or more signals, from which UE_{A} 102 will determine heading information for UE_{B} 104, containing positioning information associated with UE_{B} 104.

As mentioned above, in other examples, UE_{A} 102 and UE_{B} 104 establish a PC5-RRC connection, which can facilitate UE_{A} 102 requesting heading information from UE_{B} 104 when compared to waiting for an opportunistic discovery message. Thus, in these examples, UE_{B} 104 receives, via a PC5-RRC message from UE_{A} 102, a request for UE_{B} 104 to transmit positioning information associated with UE_{B} 104. In response, UE_{B} 104 transmits one or more signals, from which UE_{A} 102 will determine heading information for UE_{B} 104, containing positioning information associated with UE_{B} 104. In further examples, the PC5-RRC connection may also facilitate UE_{B} 104 sharing more information with UE_{A} 102, such as measured Uu Reference Signal Received Power (RSRP) and a camped Cell identifier (Cell ID), in addition to Sidelink-RSRP (SL-RSRP) as part of the heading information for UE_{B} 104.

When UE_{A} 102 determines/obtains the heading information for UE_{B} 104, UE_{A} 102 reports the heading information to base station 106. Base station 106 receives, from UE_{A} 102, the heading information of UE_{B} 104. In some examples, UE_{A} 102 reports the location, positioning, and/or heading information for UE_{B} 104 to base station 106 via dedicated signaling or as traffic data (e.g., when in an RRC CONNECTED state).

In other examples, UE_{A} 102 reports the heading information for UE_{B} 104 to base station 106 by performing all or part of a Radio Resource Control (RRC) Connection procedure to base station 106. Thus, in some examples, UE_{A} 102 transitions to an RRC CONNECTED state with base station 106 before reporting the heading information for UE_{B} 104 to base station 106. However, in other examples, during the establishment request of the RRC Connection, UE_{A} 102 provides the heading information to base station 106 in an RRC Establishment Request message (e.g., Msg 3). After base station 106 receives the heading information in Msg 3 and before the RRC Connection is completed, base station 106 simply releases UE_{A} 102 without needing UE_{A} 102 to be connected to base station 106.

In other examples, UE_{A} 102 reports the heading information for UE_{B} 104 to base station 106 via a Small Data Transmission (SDT). SDT is a procedure allowing data and/or signaling transmission while remaining in an RRC_INACTIVE state (e.g., without transitioning to an RRC_CONNECTED state). In some examples, SDT is enabled on a radio bearer basis and is initiated by the UE when (1) less than a configured amount of uplink data awaits transmission across all radio bearers for which SDT is enabled, (2) the downlink Reference Signal Received Power (RSRP) is above a configured threshold, and (3) a valid SDT resource is available. The SDT procedure is initiated with either a transmission over the Random-Access Channel (RACH) (e.g., which is configured via SIB) or over Type 1 Configured Grant (CG) resources, whereby the UE transmits a packet without the need for sending a scheduling request to the base station. For RACH, the network configures 2-step and/or 4-step Random-Access (RA) resources for SDT.

Upon receiving the heading information of UE_{B} 104 from UE_{A} 102, base station 106 utilizes the heading information of UE_{B} 104 to select a set of beams over which to transmit the SSB signal to UE_{B} 104, in some examples. In other examples, base station 106 determines, based on the heading information of UE_{B} 104, which precoder to apply to the SSB signal before transmitting the SSB signal via a second set of one or more consecutive beams. As described above, in some examples, the UE devices exchange positioning information by establishing a PC5 connection. In other examples, UE_{A} 102 measures reference signals transmitted by UE_{B} 104 to compute the inter-UE distance, dA_{B}. UE_{A} 102 reports the heading information for UE_{B} 104 and the distance dA_{B} to base station 106. Base station 106 applies this inter-UE distance dA_{B} to derive the distance de, the Angle-of-Separation θ, and a direction associated with the heading information of UE_{B} 104. Once base station 106 determines the second set of one or more consecutive beams and/or precoder, base station 106 serially transmits a set of SSB signals via the second set of one or more consecutive beams in the direction associated with the heading information of UE_{B} 104.

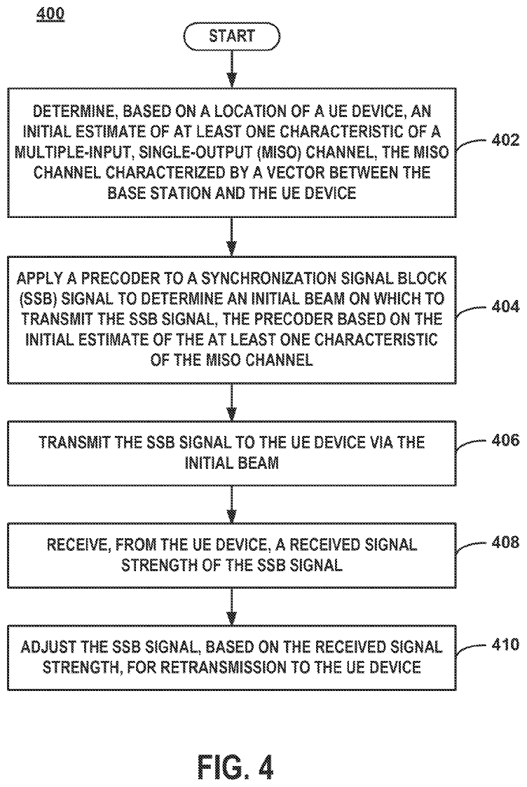

FIG. 4 is a flow chart of an example of a method 400 performed at a base station to determine an initial beam, based on a location of a UE device, over which to transmit an SSB signal. At step 402, a base station determines, based on a location of a UE device, an initial estimate of at least one characteristic of a MISO channel. The MISO channel is characterized by a vector between the base station and the UE device. At step 404, the base station applies a precoder to an SSB signal to determine an initial beam on which to transmit the SSB signal. The precoder is based on the initial estimate of the at least one characteristic of the MISO channel. At step 406, the base station transmits the SSB signal to the UE device via the initial beam. At step 408, the base station receives, from the UE device, a received signal strength of the SSB signal. At step 410, the base station adjusts the SSB signal, based on the received signal strength, for retransmission to the UE device.

In other examples, one or more of the steps of method 400 may be omitted, combined, performed in parallel, or performed in a different order than that described herein or shown in FIG. 4. In still further examples, additional steps may be added to method 400 that are not explicitly described in connection with the example shown in FIG. 4.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A base station comprising:
a controller configured to determine, based on a location of a user equipment (UE) device, an initial set of one or more consecutive beams over which to transmit a Synchronization Signal Block (SSB) signal; and
a transmitter configured to serially transmit the SSB signal to the UE device via the initial set of one or more consecutive beams,
in response to failure of the UE device to receive the SSB signal transmission via the initial set of one or more consecutive beams, the controller further configured to determine, based on heading information of the UE device, a second set of one or more consecutive beams over which to transmit the SSB signal, the transmitter further configured to serially transmit the SSB signal to the UE device via the second set of one or more consecutive beams in a direction associated with the heading information of the UE device.

2. The base station of claim 1, further comprising:
a receiver configured to receive, from the UE device, periodic transmissions,
the controller further configured to determine, based on the periodic transmissions, the heading information of the UE device.

3. The base station of claim 2, wherein the transmitter is further configured to transmit, to the UE device, one or more instructions instructing the UE device when to begin and end the periodic transmissions.

4. The base station of claim 3, wherein the transmitter is further configured to transmit the one or more instructions in a System Information Block (SIB) message.

5. The base station of claim 3, wherein the one or more instructions contain a Destination Layer 2 identifier (ID).

6. The base station of claim 3, wherein the transmitter is further configured to transmit the one or more instructions in a paging message that triggers the periodic transmissions and provides a duration for the periodic transmissions.

7. The base station of claim 3, wherein the transmitter is further configured to transmit the one or more instructions via dedicated signaling.

8. The base station of claim 1, further comprising:
a receiver configured to receive, from another UE device, the heading information of the UE device.

9. The base station of claim 8, wherein the receiver receives the heading information of the UE device via a Small Data Transmission (SDT).

10. The base station of claim 8, wherein the controller is further configured to apply a precoder to the SSB signal before transmitting the SSB signal via the second set of one or more consecutive beams, the precoder based on the heading information of the UE device.

11. A first user equipment (UE) device comprising:
a receiver configured to receive, from a second UE device, a request to establish a PC5 communication link with the first UE device; and
a transmitter configured to transmit, to the second UE device via the PC5 communication link, one or more signals from which the second UE device determines heading information for the first UE device and reports the heading information to a base station,
the receiver further configured to receive, from the base station, a Synchronization Signal Block (SSB) signal transmitted as part of a set of SSB signals serially transmitted via a set of one or more consecutive beams in a direction associated with the heading information of the first UE device.

12. The first UE device of claim 11, wherein the second UE device reports the heading information for the first UE device to the base station via a Small Data Transmission (SDT).

13. The first UE device of claim 11, wherein the second UE device transitions to a Radio Resource Control (RRC) CONNECTED state with the base station before reporting the heading information for the first UE device to the base station.

14. The first UE device of claim 11, wherein the receiver is further configured to receive, via a discovery message from the second UE device, a request for the first UE device to transmit positioning information associated with the first UE device, the one or more signals from which the second UE device determines heading information for the first UE device containing the positioning information associated with the first UE device.

15. The first UE device of claim 11, wherein the receiver is further configured to receive, via a PC5-Radio Resource Control (PC5-RRC) message from the second UE device, a request for the first UE device to transmit positioning information associated with the first UE device, the one or more signals from which the second UE device determines heading information for the first UE device containing the positioning information associated with the first UE device.

16. The first UE device of claim 11, wherein the one or more signals from which the second UE device determines heading information for the first UE device are reference signals.
